(19) United States
(12) Patent Application Publication
(10) Pub. No.: US 2012/0224052 A1
(43) Pub. Date: Sep. 6, 2012

(54) Method for Measuring Real Size of Object Using Camera of Mobile Terminal

(76) Inventor: Sang Mo Bae, Mapo-gu (KR)

(21) Appl. No.: 13/364,725

(22) Filed: Feb. 2, 2012

(30) Foreign Application Priority Data
Mar. 3, 2011 (KR) 10-2011-19172

(51) Int. Cl. H04N 7/18

(52) U.S. Cl. 348/135; 348/E07.085

(57) ABSTRACT

A method for measuring a real size of an object using a camera of a mobile terminal, includes the steps (1) recognizing an object image taken using a camera of a mobile terminal; (2) measuring a size of an object image recognized in step (1); (3) measuring a distance between the object and the camera; and (4) computing a real size of the object using the characteristic of the camera, the size of the object image measured in step (2), and the distance between the object measured in step (3) and the camera.

### TECHNICAL FIELD

The present invention relates to a method for measuring a real size of an object, and in more particular to a method for measuring a real size of an object using a camera of a mobile terminal.

### BACKGROUND ART

People experience a lot of things during their lives and sometimes want to measure the length, height and area of a certain thing such as a building or an object. For example, people want to know a real size of a certain thing such as a life item such as furniture, a desk, or the like or want to know the height of a building standing by a street.

In the event of furniture, a desk or the like, its real size can be easily obtained by asking a staff or a manufacturer. In the event that it is needed to know the size of a show window or if there is not a staff to ask or if a sale place with a show window is closed, knowing a real size of the same is impossible. In the event of a life item, not furniture, no information on a real size is provided. Measuring the size in person using a scale is a way to know its real size. People sometimes wonder a real height of a building on way to somewhere. In this case, the real size of a building might vary depending on a standing position, so it is almost impossible to know a real height with naked eyes, so the people ask a janitor of the building which produces some troublesome.

As a cellular phone is fast advanced and widely used, almost the mobile terminal is equipped with a camera. The user does not need to carry with a dedicated camera in person, so the user can take photos or motion pictures conveniently anywhere anytime and can store the taken photos or motion pictures in a mobile terminal. In the event of a smart device such as a smart phone, a tablet PC, etc., it is equipped with a number of advanced functions some of which can be changed or upgraded based on an operation system installed. There might be a potential to use in such smart device when measuring a real size with a camera equipped in the mobile terminal and the operating system installed therein. Unfortunately, there is not any way for measuring a real size of an object by using a camera equipped in a mobile terminal, so the users have a lot of problems in measuring a real size of a thing.

### DISCLOSURE OF THE INVENTION

Accordingly, it is an object of the present invention to provide a method for measuring a real size of an object using a camera of a mobile terminal which overcomes the problems encountered in a conventional art.

It is another object of the present invention to provide a method for measuring a real size of an object using a camera of a mobile terminal which makes it possible to measure a size of an object image taken by a camera of a mobile terminal and a distance between an object and a camera, and compute a real size of an object taken by a characteristic of a camera such as a focus distance and a measured value, thus measuring a real size of an object in faster and easy ways as compared to a measurement of using a scale or the same.

To achieve the above objects, there is provided a method for measuring a real size of an object using a camera of a mobile terminal, comprising:

(1) a step for recognizing an object image taken using a camera of a mobile terminal;

(2) a step for measuring a size of an object image recognized n the step (1);

(3) a step for measuring a distance between the object and the camera; and

(4) a step for computing a real size of the object using the characteristic of the camera, the size of the object image measured in the step (2), and the distance between the object measured in the step (3) and the camera.

Preferably, there is further provided (5) a step for outputting a real size of the object computed in the step (4) to the mobile terminal.

More preferably, in the step (5), an error range occurring during the computation process of the step (4) is outputted.

More preferably, in the step (5), a distance between the object measured in the step (3) and the camera is further outputted.

Preferably, the distance between the object and the camera is measured based on the lens formula.

Preferably, in the step (3), the distance between the object and the camera is measured using a distance sensor.

Preferably, the object image recognized in the step (1) is at least one, and the step (2) includes a step for selecting one object image from at least one object image.

Preferably, the step (2) includes:

a step for selecting the kind of a size to be computed, from a user of the mobile; and

a step for measuring the size of the object image corresponding to the kind of the selected size.

More preferably, the kinds of the sizes are a length, a height or an area.

### ADVANTAGEOUS EFFECTS OF THE INVENTION

According to a method for measuring a real size of an object using a camera of a mobile terminal of the present invention, it is possible to measure a size of an object image taken by a camera of a mobile terminal and a distance between an object and a camera, and compute a real size of an object taken by a characteristic of a camera such as a focus distance and a measured value, thus measuring a real size of an object in faster and easy ways as compared to a measurement of using a scale or the same.

### BRIEF DESCRIPTION OF THE DRAWINGS

The present invention will become better understood with reference to the accompanying drawings which are given only by way of illustration and thus are not limitative of the present invention, wherein;

FIG. 1 is a view illustrating a method for measuring a real size of an object using a camera of a mobile terminal according to an embodiment of the present invention;

FIG. 2 is a view illustrating a construction of a system for implementing a method for measuring a real size of an object using a camera of a mobile terminal according to an embodiment of the present invention;

FIG. 3 is a flow chat of a method for measuring a real size of an object using a camera of a mobile terminal according to an embodiment of the present invention; and

FIG. 4 is a flow chart of a step S200 in a method for measuring a real size of an object using a camera of a mobile terminal according to an embodiment of the present invention.

### MODES FOR CARRYING OUT THE INVENTION

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

The term “connection” or “connected” used throughout the specification and claims means a direct connection or an indirect connection through a certain element, and the term “comprise” or “include” used throughout the specification and claims means that it does not eliminate alternative elements, but includes another element unless otherwise stated.

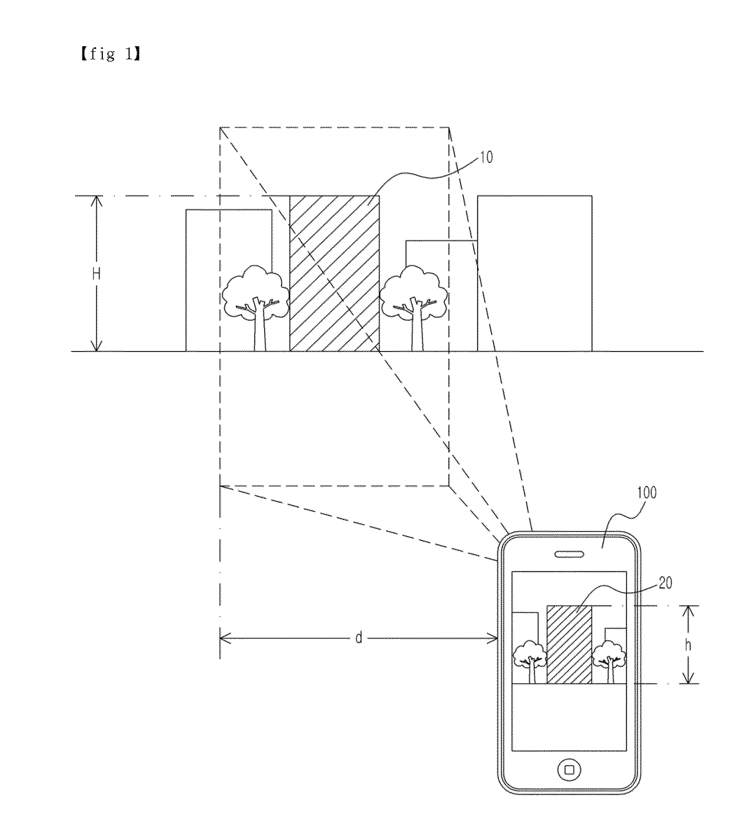

FIG. 1 is a view illustrating a method for measuring a real size “H” of an object 10 using a camera 110 of a mobile terminal 100 according to an embodiment of the present invention. As shown in FIG. 1, a method for measuring a real size “H” of an object 10 using a camera 110 of a mobile terminal 100 according to an embodiment of the present invention is basically directed to taking a photo of an object 10 such as a building or the like using a mobile terminal 100, thus measuring a real size “H” of an object 10 using a size “h” of an object image 20 taken using a mobile terminal 100 and a distance “d” between an object 10 and a camera 110.

The mobile terminal 100 according to the present invention might be a mobile communication terminal, a PDA (Personal Digital Assistant), a DMB (Digital Multimedia Broadcasting), a MP3 player, an electronic book terminal, a smart phone, a tablet PC, etc., provided that the mobile terminal 100 according to the present invention is not limited to the above disclosed items, but might be any type of a device if it is capable of analyzing a size of an object 10 with a camera 110, thus performing the functions of a mobile terminal 100 of the present invention.

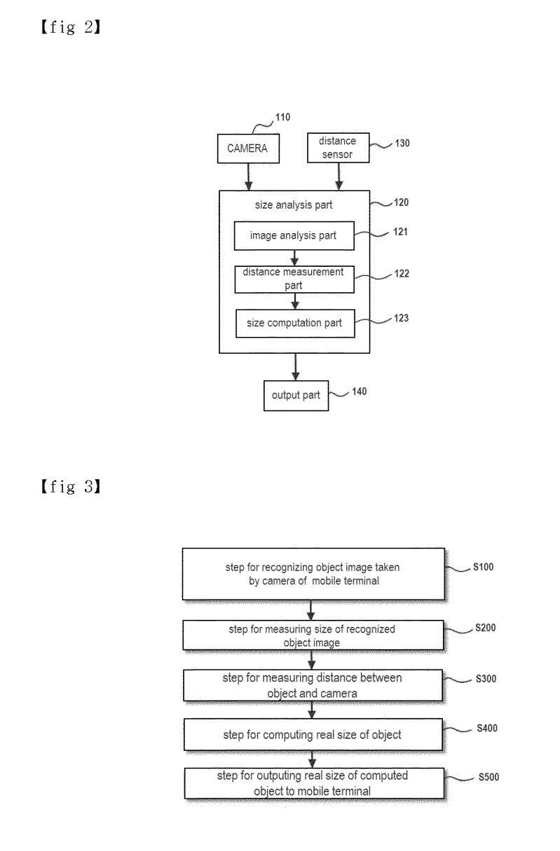

FIG. 2 is a view illustrating a construction of a system for implementing a method for measuring a real size of an object using a camera of a mobile terminal according to an embodiment of the present invention. As shown therein, the system for implementing a method for measuring a real size of an object using a camera of a mobile terminal according to an embodiment of the present invention comprises a camera 110 and a size analyzing part 120, and further comprises a distance sensor 130 and an output part 140.

The camera 110 is directed to directly taking a photo of the object 10, and has a certain characteristic such as a focus distance f. As shown in FIG. 1, in the present invention is directed to taking a photo of the object 10 using a camera 110 of a mobile terminal 100, thus measuring a real size “H” of the object using the same. For the above operations, there is provided a constant focus distance “f” for each lens of the camera 110. When the focus distance “f” is designed to vary, the camera 110 is designed to a function of transferring the varied focus distance “f” to the size analysis part 120 which will be described later.

The size analysis part 120 is designed to analyze and compute the size of the object 10 from the image taken by the camera 110. As shown in FIG. 2, the size analysis part 120 comprises an image analysis part 121, a distance measurement part 122, and a size computation part 123.

The image analysis part 121 is directed to extracting an object image 20 through a contour analysis or the like of the object image 20 the size of which is to be measured by analyzing the image taken by the camera 110, thus measuring the size “h” of the extracted object image 20, namely, the size of the object 10 formed at an image sensor of the camera 110 through the lens.

The distance measurement part 122 is directed to analyzing and measuring the distance “d” between the object 10 and the camera 110. It is possible to measure the distance “d” between the object 10 and the camera 110 by using an information from the distance sensor 130 or measure the distance “d” between the object 10 and the camera 110 based on the formula of the lens.

The size computation part 123 is directed to computing a real size “H” of the object 10 using the information analyzed by the image analysis part 121 and the distance measurement part 122. In more details, it is possible to compute the real size “H” of the object 10 using the characteristics of the camera 110, the size “h” of the object image 20 analyzed by the image analysis part 121 and the distance between the object 10 analyzed by the distance measurement part 122 and the camera 110.

The distance sensor 130 is directed to measuring a distance “d” between the object 10 and the camera 110 and is formed of an infrared ray distance sensor or a laser distance sensor. The distance “d” between the object 10 and the camera 110 might be obtained by the lens formula or might be a really measured value collected using the sensor.

The output part 140 is directed to outputting the data analyzed by the size analysis part 120 for the user to see. The output part 40 might be a display window of the mobile terminal 100 of the present invention and might be formed of a touch screen, a speaker or the like.

FIG. 3 is a flow chat of a method for measuring a real size “H” of an object 10 using a camera 110 of a mobile terminal 100 according to an embodiment of the present invention. As shown therein, the method for measuring a real size “H” of an object 10 using a camera 110 of a mobile terminal 100 according to an embodiment of the present invention comprises a step S100 for recognizing an object image 20 taken by using the camera 110 of the mobile terminal 100, a step S200 for measuring a size “h” of the recognized object image 20, a step S300 for measuring a distance “d” between the object 10 and the camera 110, a step for computing a real size “H” of the object 10, and a step S500 for outputting the computed real size “H” of the object 10 to the mobile terminal 100.

In the step S100, it is possible to recognize the object image 20 taken by using the camera 110 of the mobile terminal 100. As shown in FIG. 1, when a certain object 10 is taken by the camera 11 of the mobile terminal 10, the landscapes around the object 10 can be taken. In the step S100, the background and object image 20 are separated through a contour analysis or the like, thus recognizing the object image 20. Here, since multiple objects 10 might be taken, at least one object image 20 can be recognized in the step s100.

In the step S100, it is possible to directly recognize the object image 20 shown through the camera 110 or it is possible to directly recognize the object image 20 from an image file obtained by taking using the camera 110.

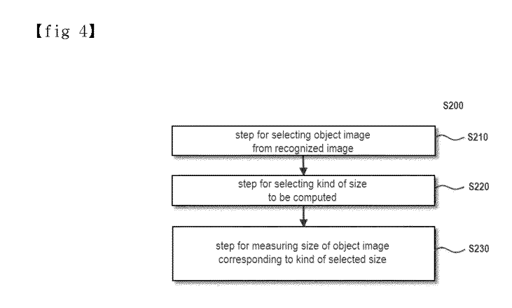

In the step S200, it is possible to measure the size “h” of the object image 20 recognized in the step S100. The step S200 is directed to measuring the size “h” of the object image 20 formed at the image sensor of the camera 110 of the mobile terminal 100. Only the size “h” of the object image 20 recognized by separating the background and the object 10 in the step S100. The detailed operations of the step S200 will be described later with reference to FIG. 4.

In the step S300, the distance “d” between the object 10 and the camera 110 can be measured. The method for measuring a real size “H” of an object 10 using a camera 110 of a mobile terminal 100 according to an embodiment of the present invention needs a distance “d” between the object 10 and the camera 110 so as to compute a real size “H” of the object 10. As a method for measuring the distance “d” between the object 10 and the camera 110, there is a method of using the lens formula and a method of using the distance sensor 130.

The step S300 is directed to measuring the distance “d” between the object 10 and the camera 110 based on the lens formula. The lens formula for measuring the distance “d” between the object 10 and the camera 110 can be expressed as in the following formula 1. In the formula 1, the character “a” represents the distance between the object 10 and the center of the lens of the camera 110, and “b” represents the distance between the center of the lens of the camera 110 to the image, and “f” represents a focus distance.

$$\frac{1}{a} + \frac{1}{b} = \frac{1}{f} \qquad [ Formula 1 ]$$

In the meantime, in the embodiment of the present invention, if it is assumed that the distance from the center of the lens and the boundary edge of the lens is too small to neglect, “a” might be approximated to “d” which is the distance between the object 10 to the end of the lens of the camera 110. So, the distance “d” between the object 10 and the camera 110 can be computed as in the following formula 2 by using the above formula 1 and the approximation.

$$d = \frac{bf}{b - f} \qquad [ Formula 2 ]$$

In the meantime, the distance “d” between the object 10 and the camera 110 can be measured using the distance sensor 130. The distance sensor 130 serves to measure the distance “d” between the object 10 and the camera 110, provided that since most of the known distance sensors 130 are designed to measure a distance based on the time that the outputted signal returns, there might be an error in the measurement if there is a certain obstacle between the object 10 the size of which is to be measured, and the distance sensor 130.

In the step S400, it is possible to measure the real size “H” of the object 10 using the characteristic of the camera 110, the size “h” of the object image 20 measured in the step S200 and the distance between the object 10 and the camera 110 measured in the step S300. Here, the kinds of the sizes might be a length or an area.

The step S400 necessarily needs a focus distance “f” as the characteristic of the camera 110. The lens formula 3 for computing the size of the object 10 with respect to the size of the image is as follows.

$$A = Bx ( \frac{a}{f} - 1 ) \qquad [ Formula 3 ]$$

In the formula, character “A” represents the size of the object 10, “B” represents the size of the image, “f” represents the focus distance, “a” represents the distance between the center of the lens and the object. As described in the step S300, “a” might be approximated to the distance “d” between the object 10 and the camera 110, and the size “h” of the object image 20 which is the size of the image is measured in the step S200, it is possible to obtain the size of the object 10 from the focus distance “f” of the camera 110. As shown in FIG. 1, the height of the building can be computed by the following formula 4 using the focus distance “f”.

$$H = h \times ( \frac{d}{f} - 1 ) \qquad [ Formula 4 ]$$

The height, the width and the area of the object 10 can be measured in the same manner based on the formula 4.

In the meantime, the real size “H” of the object 10 measured in the step S400 of the method for measuring the real size “H” of the object 10 using the camera 110 of the mobile terminal 100 according to an embodiment of the present invention might have a certain error due to an inaccuracy in terms of the recognition of the object image 20 in the step S100 due to a change in the characteristic of the camera 110, the shakes of the hands while taking a picture of the object 10 using the camera 110, and the clearness, brightness and lighting of the image and the measurement errors occurring at the distance sensor 130. It is possible to measure the real size “H” of the object 10 within a common error range.

In the step S500, the real size “H” of the object 10 measured in the step S400 can be outputted to the mobile terminal. Here, the real size “H” of the object 10 is outputted to the output part 140 of the mobile terminal 100. The voice output might be used instead of a visual output method such as a text or an image. In the step S500, the distance “d” between the object 10 and the camera 110 measured in the step S300 can be further outputted, and the error range of the real size “H” of the object 10 measured in the step S400 can be further outputted. As such additional information can be outputted, the accuracy and reliability of the measurement of the real size “H” of the object 10 using the camera 110 of the mobile terminal 100 according to an embodiment of the present invention can be enhanced.

FIG. 4 is a flow chart of a step S200 in a method for measuring a real size of an object using a camera of a mobile terminal according to an embodiment of the present invention.

As shown therein, the step S200 of the method for measuring the real size “H” of the object 10 using the camera 110 of the mobile terminal 100 according to an embodiment of the present invention further comprises a step S210 for selecting the object image 20 from the recognized image, a step S220 for selecting the kinds of the sizes to be computed, and a step S230 for measuring the size “h” of the object image 20 corresponding to the kind of the selected size.

In the step S210, the object image 20 can be selected from the images recognized in the step S100. As shown in FIG. 1, when taking a picture using the camera 110, other objects might be taken. In the event that it is impossible to adjust the size “h” of the object image 20 by moving the mobile terminal 100, more other objects can be taken. Therefore, the step S210 is performance so as to check whether the image of the object 10 recognized in the Step S100 is the object 10 the size of which is to be measured, so that the size of the correct object 10 can be measured. In the step S210, since one object image 20 is selected from at least one object images 20 by the user, it is possible to measure the object image 20 which is the real object the size of which is to be measured.

In the step S220, the kinds of the sizes can be selected from the user of the mobile terminal 100. At this time, the kinds of the sizes are formed of a length, a height and an area. For example, as shown in FIG. 1, when a user wants to measure the real size of a building, the user can measure the height, width (length) and area of the building. When the user measures the width of the building, the height can be also measured. In the step S200, it is possible to select the kind of the size when the user selects a certain size.

In the step S230, the size “h” of the object image 20 corresponding to the kind of the size can be measured. Namely, depending on the selection in the step S220, the size of the kind that the user wants to measure can be measured. At this time, it is possible to measure the size “h” of the object image 20 selected in the step S210 corresponding to the kind of the size selected in the step S220.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

[Descriptions of the reference numerals]

| | |
|---|---|
| 10: object | 20: object image |
| 100: mobile terminal | 110: camera |
| 120: size analysis part | 121: image analysis part |
| 122: distance measurement part | 123: size computation part |
| 130: distance sensor | 140: output part |

d: distance between object and camera

| | |
|---|---|
| h: size of object image | H: real size of object |

S100: step for recognizing object image taken by camera
of mobile terminal
S200: step for measuring size of recognized object image
S210: step for selecting object image from recognized image
S220: step for selecting kind of size to be computed
S230: step for measuring size of object image corresponding
to kind of selected size
S300: step for measuring distance between object and camera
S400: step for computing real size of object
S500: step for outputting real size of computed object to mobile terminal

What is claimed is:

1. A method for measuring a real size of an object using a camera of a mobile terminal, comprising:
(1) a step for recognizing an object image taken using a camera of a mobile terminal;
(2) a step for measuring a size of an object image recognized n the step (1);
(3) a step for measuring a distance between the object and the camera;
(4) a step for computing a real size of the object using the characteristic of the camera, the size of the object image measured in the step (2), and the distance between the object measured in the step (3) and the camera; and
(5) a step for outputting a real size of the object computed in the step (4) to the mobile terminal,
wherein in said step (5), an error range occurring during the computation process of the step (4) is outputted;
there is at least one object image recognized in the step (1); and
said step (2) is formed of a step for selecting one object image among at least one object images.

2. (canceled)

3. (canceled)

4. The method of claim 1, wherein in said step (5), the distance between the object measured in the step (3) and the camera is further outputted.

5. The method of claim 1, wherein in said step (3), the distance between the object and the camera is measured based on the lens formula like the following formula,
$$A = B \times ( \frac{a}{f} - 1 )$$
where A is the size of an object, B is the size of an image, f is a focus distance, and a is a distance from the center of the lens to the object.

6. The method of claim 1, wherein in said step (3), the distance between the object and the camera is measured using a distance sensor.

7. (canceled)

8. The method of claim 1, wherein said step (2) includes:
a step for selecting the kind of a size to be computed, from a user of the mobile; and
a step for measuring the size of the object image corresponding to the kind of the selected size.

9. The method of claim 8, wherein said kinds of the sizes are a length, a height or an area.
